(19) United States
(12) Patent Application Publication
(10) Pub. No.: US 2019/0011755 A1
(43) Pub. Date: Jan. 10, 2019

(54) DISPLAY PANEL AND MANUFACTURING METHOD THEREOF

(71) Applicants: HKC Corporation Limited, Shenzhen (CN); Chongqing HKC Optoelectronics Technology Co., Ltd, Chongqing (CN)

(72) Inventor: YU-JEN CHEN, Chongqing (CN)

(21) Appl. No.: 15/744,843

(22) PCT Filed: May 10, 2017
(86) PCT No.: PCT/CN2017/083780

§ 371 Date: Jan. 15, 2018

(30) Foreign Application Priority Data
May 5, 2017 (CN) 2017103136505

(51) Int. Cl. G02F 1/1345; G02F 1/1343; G02F 1/1362; G02F 1/1341

(52) U.S. Cl. CPC G02F 1/13452; G02F 1/1341; G02F 1/136286; G02F 1/134309

(57) ABSTRACT

The present application discloses a display panel and a manufacturing method thereof. The display panel includes a first substrate, a second substrate arranged opposite to the first substrate, and liquid crystal layer positioned between the first substrate and the second substrate, wherein the first substrate includes a gate circuit and a display area arranged corresponding to the liquid crystal layer, the first substrate further includes a first transparent electrode, and the second substrate includes a second transparent electrode and the second transparent electrode is provided with a hollow area corresponding to the gate circuit.

### TECHNICAL FIELD

The present application relates to the technical field of displays, and more particularly to a display panel and a manufacturing method thereof.

### BACKGROUND

With the development and progress of science and technology, liquid crystal display apparatuses become a main product of display apparatuses due to such advantages as a thin body, power savings, low radiation, etc. and are widely used. Most liquid crystal display apparatuses in the current market are backlit liquid crystal display apparatuses, each including a liquid crystal panel and a backlight module. Working principle of the liquid crystal panel is that liquid crystals are put in two parallel glass substrates, and a driving voltage is applied to the two glass substrates to control rotation of the liquid crystals, to refract light rays of the backlight module to generate a picture.

Thin film transistor-liquid crystal display apparatuses (TFT-LCD apparatuses) currently maintain a leading status in the display field because of low power consumption, excellent picture quality, high production yield and other properties. Similarly, the TFT-LCD apparatus comprises a liquid crystal panel and a backlight module. The liquid crystal panel comprises a color filter substrate (CF substrate), a thin film transistor substrate (TFT substrate) and a mask, and transparent electrodes on relative inner sides of the above substrates. A layer of liquid crystals (LC) is positioned between two substrates.

For thin film transistor-liquid crystal display apparatuses (TFT-LCD apparatuses), to highlight integration sense of a real picture, a narrow frame and a non-edge frame gradually become an important development direction of the liquid crystal display apparatuses. But when the narrow frame and the non-edge frame are realized, production cost can be reduced, which is the pursuit of those of ordinary skill.

Following the development trend, a gate driver on array (GOA) circuit is widely used. The GOA circuit is manufactured together with an in-plane structure of the array substrate in a film formation manner identical with semiconductor devices such as in-plane liquid crystal drive switches, etc. The emergence of the GOA circuit omits the cost of a scanning line drive chip. Meanwhile, a flexible printed circuit (FPC) is not required to be welded to an edge of a liquid crystal display panel. The GOA circuit not only facilitates control and design of the liquid crystal display apparatuses, but also greatly reduces width of the edges of the liquid crystal display apparatuses.

However, gate driver on array (GOA) technologies also have some problems which cannot be well solved temporarily, such as a problem of excessive resistance capacitance (RC) load of a related circuit.

It should be noted that the above introduction of the technical background is described only to clearly and fully describe the technical solution of the present application conveniently, and facilitate the understanding of those of ordinary skill in the art. The above-mentioned technical solutions shall not be considered as well known solutions by those of ordinary skill in the art just because these solutions are described in the background of the present application.

### SUMMARY

A technical problem to be solved by the present application is to provide a display panel reducing resistance capacitance (RC) load and a manufacturing method of the display panel.

The present application provides a display panel, comprising:

a first substrate;

a second substrate arranged opposite to the first substrate; and

a liquid crystal layer positioned between the first substrate and the second substrate.

The first substrate comprises a gate circuit a display area arranged corresponding to the liquid crystal layer.

The first substrate further includes a first transparent electrode, the second substrate includes a second transparent electrode and the second transparent electrode is provided with a hollow area corresponding to the gate circuit.

Further, the gate circuit comprises at least one gate driver chip and at least one leading wire for transmitting a signal of the gate driver chip into the display area.

The hollow area is arranged corresponding to the gate driver chip. In the implementation solution, the gate driver chip in the gate circuit is hollowed, and it is known from a parallel capacitance formula that C=ϵA/d. Electrodes on both ends must be arranged to form parallel plate capacitance. A portion of the second transparent electrode corresponding to the gate driver chip is hollowed and has no parallel capacitance. Therefore, the entire capacitance of the entire gate circuit is reduced, and an entire capacitance value is reduced to alleviate the problem of excessive RC load.

Further, the gate circuit comprises at least one gate driver chip and at least one leading wire for transmitting a signal of the gate driver chip into the display area.

The hollow area is arranged corresponding to the leading wire. In the implementation solution, the leading wire in the gate circuit is hollowed, and it is known from a parallel capacitance formula that C=ϵA/d. Electrodes on both ends must be arranged to form a parallel plate capacitance. Portion of the second transparent electrode corresponding to the leading wire is hollowed and has no parallel capacitance. Therefore, the entire capacitance of the entire gate circuit is reduced, and an entire capacitance value is reduced to alleviate the problem of excessive RC load.

Further, the gate circuit comprises at least one gate driver chip and at least one leading wire for transmitting a signal of the gate driver chip into the display area.

The hollow area is arranged corresponding to the gate driver chip and the leading wire. In the implementation solution, the leading wire and the gate driver chip in the gate circuit are hollowed, and it is known from a parallel capacitance formula that C=ϵA/d. Electrodes on both ends must be arranged to form parallel plate capacitance. Portions of the second transparent electrode corresponding to the leading wire and the gate driver chip are hollowed and have no parallel capacitance. Therefore, the entire capacitance of the entire gate circuit is reduced, and an entire capacitance value is reduced to alleviate the problem of excessive RC load.

Further, the hollow area is formed in an exposing and developing manner. In the implementation solution, the hollow area can be finished in an exposing and developing manner, and certainly can also be processed in other applicable manners.

The present application also discloses a manufacturing method of a display panel comprising:

forming a first substrate;

forming a second substrate arranged opposite to the first substrate;

filling liquid crystals between the first substrate and the second substrate to form a liquid crystal layer;

exposing and developing on the periphery of a first display area to form a gate circuit;

arranging a first transparent electrode and a second transparent electrode corresponding to the first substrate and the second substrate respectively; and

hollowing the second transparent electrode corresponding to a location of the gate circuit.

Further, the gate circuit comprises at least one gate driver chip and at least one leading wire for transmitting a signal of the gate driver chip into the display area.

The second transparent electrode is hollowed in corresponding to a location of the gate driver chip. In the implementation solution, the gate driver chip in the gate circuit is hollowed, and it is known from a parallel capacitance formula that C=ϵA/d. Electrodes on both ends must be arranged to form parallel plate capacitance. Portion of the second transparent electrode corresponding to the gate driver chip is hollowed and has no parallel capacitance. Therefore, the entire capacitance of the entire gate circuit is reduced, and an entire capacitance value is reduced to alleviate the problem of excessive RC load.

Further, the gate circuit comprises at least one gate driver chip and at least one leading wire for transmitting a signal of the gate driver chip into the display area.

The second transparent electrode is hollowed in corresponding to a location of the leading wire. In the implementation solution, the leading wire in the gate circuit is hollowed, and it is known from a parallel capacitance formula that C=ϵA/d. Electrodes on both ends must be arranged to form a parallel plate capacitance. Portion of the second transparent electrode corresponding to the leading wire is hollowed and has no parallel capacitance. Therefore, the entire capacitance of the entire gate circuit is reduced, and an entire capacitance value is reduced to alleviate the problem of excessive RC load.

Further, the gate circuit comprises at least one gate driver chip and at least one leading wire for transmitting a signal of the gate driver chip into the display area.

The second transparent electrode is hollowed in corresponding to a location of the gate driver chip and the leading wire. In the implementation solution, the leading wire and the gate driver chip in the gate circuit are hollowed, and it is known from a parallel capacitance formula that C=ϵA/d. Electrodes on both ends must be arranged to form parallel plate capacitance. Portions of the second transparent electrode corresponding to the leading wire and the gate driver chip are hollowed and have no parallel capacitance. Therefore, the entire capacitance of the entire gate circuit is reduced, and an entire capacitance value is reduced to alleviate the problem of excessive RC load.

Further, the hollow area is formed in an exposing and developing manner. In the implementation solution, the hollow area can be finished in an exposing and developing manner, and certainly can also be processed in other applicable manners.

A GOA product has the problem of excessive RC load in design primarily because GOA has excessive capacitance. If the capacitance at the gate circuit can be effectively reduced, the load problem can be effectively alleviated. In the present application, because the second transparent electrode of the second substrate is hollowed in corresponding to a location of the gate circuit, only horizontal capacitance between the gate circuit and the second transparent electrode exists since parallel capacitance between the first transparent electrode and the second transparent electrode is greatly reduced or even eliminated corresponding to a location of the gate circuit. The capacitance is greatly reduced than that before improvement, i.e., the solution of the present application effectively reduces the capacitance, and then alleviates the problem of excessive RC load.

Specific embodiments of the present application are disclosed in detail with reference to the subsequent explanation and figures, pointing out the manner that the principle of the present application may be adopted. It should be understood the scope of the embodiments of the present application is not limited thereto. Within the range of the spirit and clause of the appended claims, embodiments of the present application include many alterations, modifications and equivalents.

Features described and/or shown for one embodiment may be used in one or more other embodiments in the same or similar manner, combined with features in other embodiments, or replace the features in other embodiments.

It should be emphasized that the terms “comprise and/or include” used herein specify the existence of features, integers, steps or assemblies, not excluding the existence or addition of one or more other features, integers, steps or assemblies.

### DESCRIPTION OF THE DRAWINGS

The drawings included are used for providing further understanding of embodiments of the present application, constitute portion of the description, are used for illustrating implementation manners of the present application, and interpreting principles of the present application together with text description. Apparently, the drawings in the following description are merely some embodiments of the present application, and for those of ordinary skill in the art, other drawings can also be formed according to the drawings without contributing creative labor. In the drawings:

FIG. 1 is a first schematic diagram of a display panel of an embodiment of the present application.

FIG. 2 is a second schematic diagram of a display panel of an embodiment of the present application.

FIG. 3 is a third schematic diagram of a display panel of an embodiment of the present application.

FIG. 4 is a fourth schematic diagram of a display panel of an embodiment of the present application.

FIG. 5 is a fifth schematic diagram of a display panel of an embodiment of the present application.

FIG. 6 is a flow chart of a manufacturing method of a display panel of an embodiment of the present application.

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly comprise one or more features. In the description of the present application, the meaning of “a plurality of” is two or more unless otherwise specified. In addition, the term “comprise” and any variant are intended to cover non-exclusive inclusion.

It should be noted in the description of the present application that, unless otherwise specifically regulated and defined, terms such as “installation”, “bonded” and “bonding” shall be understood in broad sense, and for example, may refer to fixed. bonding or detachable bonding or integral bonding, may refer to mechanical bonding or electrical bonding, and may refer to direct bonding or indirect bonding through an intermediate medium or inner communication of two elements. For those of ordinary skill in the art, the meanings of the above terms in the present application may be understood according to specific conditions.

The terms used herein are intended to merely describe specific embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features integers, steps, operation, units, assemblies and/or combinations of these.

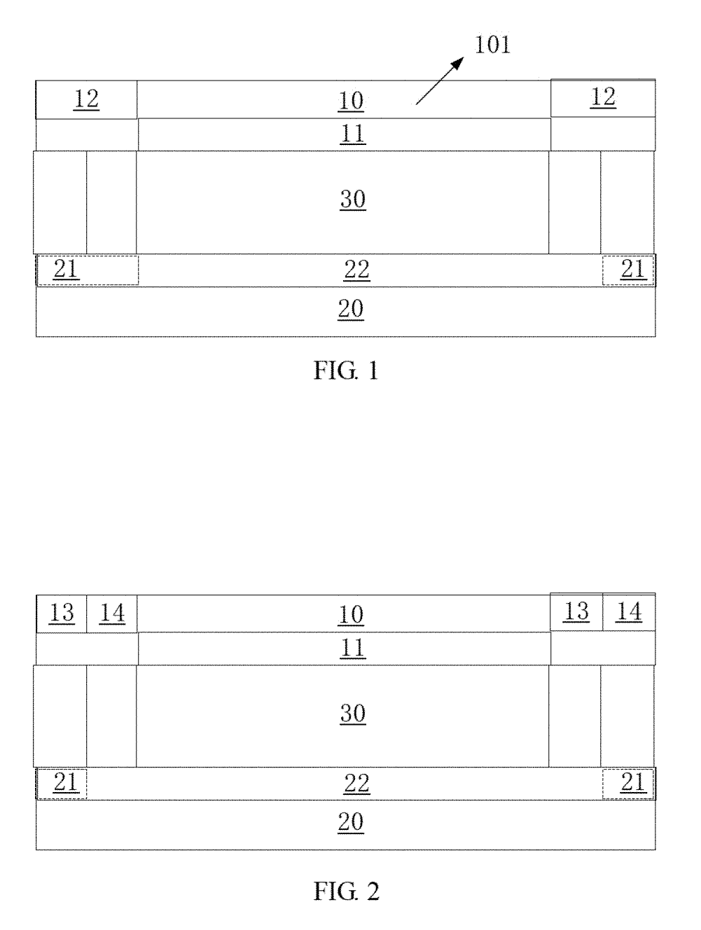

FIG. 1 is a first schematic diagram of a display panel of the present application. Referring to FIG. 1, the display panel comprises:

a first substrate 10;

a second substrate 20 arranged opposite to the first substrate 10; and

a liquid crystal layer 30 positioned between the first substrate 10 and the second substrate 20.

The first substrate 10 comprises a gate circuit 12 and a display area 101 arranged corresponding to the liquid crystal layer 30.

The first substrate 10 further comprises a first transparent electrode 11, the second substrate 20 comprises a second transparent electrode 22 and the second transparent electrode 22 is provided with a hollow area 21 corresponding to the gate circuit 12. The first substrate is an array substrate, and the second substrate is a color filter substrate.

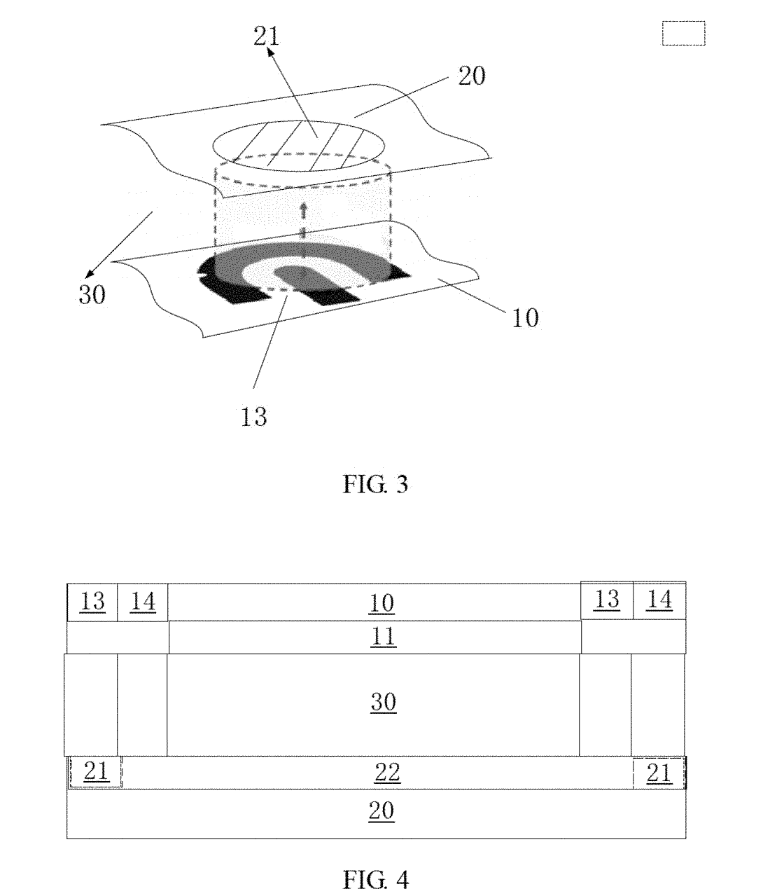

FIG. 2 is a second schematic diagram of a display panel of the present application. FIG. 3 is a third schematic diagram of a display panel of the present application. Referring to FIG. 2 and FIG. 3, in combination with FIG. 1, it can be known that the present embodiment is optional. The gate circuit 12 comprises gate driver chip 13 and a leading wire 14 for transmitting a signal of the gate driver chip 13 into the display area 101.

The hollow area 21 is arranged corresponding to the gate driver chip 13. In the implementation solution, the gate driver chip in the gate circuit is hollowed, and it is known from a parallel capacitance formula that C=ϵA/d. Electrodes on both ends must be arranged to form parallel plate capacitance. Portion of the second transparent electrode corresponding to the gate driver chip is hollowed and has no parallel capacitance. Therefore, the entire capacitance of the entire gate circuit is reduced, and an entire capacitance value is reduced to alleviate the problem of excessive RC load.

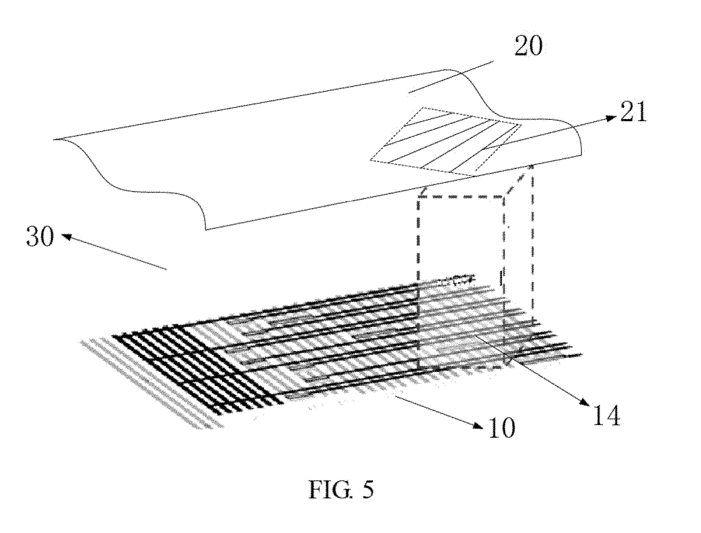

FIG. 4 is a fourth schematic diagram of a display panel of the present application. FIG. 5 is a fifth schematic diagram of a display panel of the present application. Referring to FIG. 2 and FIG. 3, in combination with FIG. 1, it can be known that the present embodiment is optional. The gate circuit 12 comprises a gate driver chip 13 and a leading wire 14 for transmitting a signal of the gate driver chip 13 into the display area 101.

The hollow area 21 is arranged corresponding to the leading wire 14. In the implementation solution, the leading wire in the gate circuit is hollowed, and it is known from a parallel capacitance formula that C=ϵA/d. Electrodes on both ends must be arranged to form a parallel plate capacitance. Portion of the second transparent electrode corresponding to the leading wire is hollowed and has no parallel capacitance. Therefore, the entire capacitance of the entire gate circuit is reduced, and an entire capacitance value is reduced to alleviate the problem of excessive RC load.

The present embodiment is based on a combination of FIG. 2 to FIG. 5. The present embodiment is optional. The gate circuit 12 comprises a gate driver chip 13 and a leading wire 14 for transmitting a signal of the gate driver chip 13 into the display area 101.

The hollow area 21 is arranged corresponding to the gate driver chip 13 and the leading wire 14. In the implementation solution, the leading wire and the gate driver chip in the gate circuit are hollowed, and it is known from a parallel capacitance formula that C=ϵA/d. Electrodes on both ends must be arranged to form parallel plate capacitance. Portions of the second transparent electrode corresponding to the leading wire and the gate driver chip are hollowed and have no parallel capacitance. Therefore, the entire capacitance of the entire gate circuit is reduced, and an entire capacitance value is reduced to alleviate the problem of excessive RC load.

The present embodiment is optional. The hollow area 21 is formed in an exposing and developing manner. In the implementation solution, the hollow area can be finished in an exposing and developing manner, and certainly can also be processed in other applicable manners.

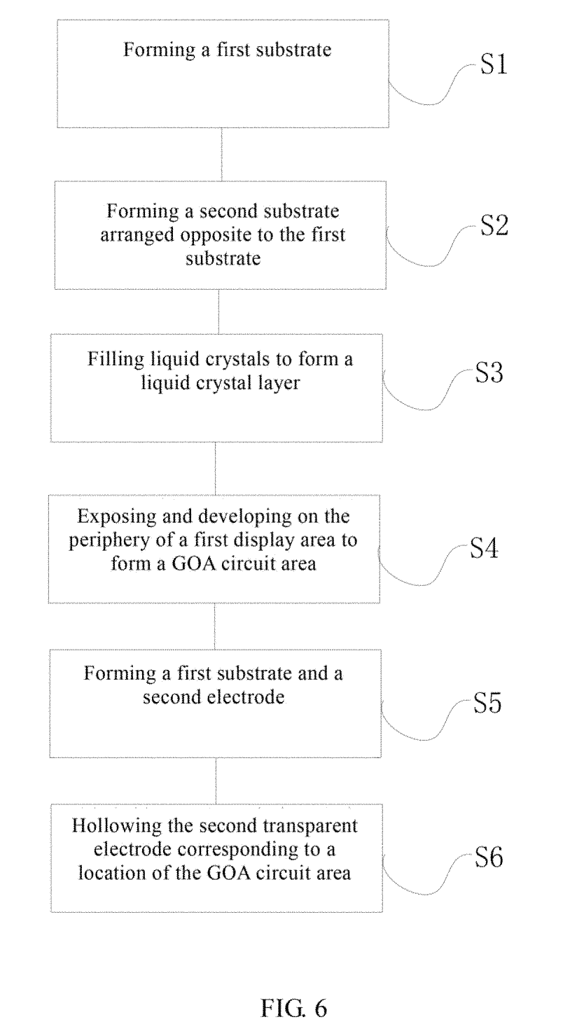

FIG. 6 is a flow chart of a manufacturing method of a display panel of an embodiment of the present application. Referring to FIG. 6, it can be known that the present application also discloses a manufacturing method of a display panel comprising:

S1: forming a first substrate.

S2: forming a second substrate arranged opposite to the first substrate.

S3: filling liquid crystals between the first substrate and the second substrate to form a liquid crystal layer.

S4: exposing and developing on the periphery of a first display area to form a gate circuit.

S5: arranging a first transparent electrode and a second transparent electrode Corresponding to the first substrate and the second substrate respectively. and

S6: hollowing the second transparent electrode corresponding to a location of the gate circuit.

The present embodiment is optional. The gate circuit comprises at least one gate driver chip and at least one leading wire for transmitting a signal of the gate driver chip into the display area.

The second transparent electrode is hollowed in corresponding to a location of the gate driver chip. In the implementation solation, the gate driver chip in the gate circuit is hollowed, and it is known from a parallel capacitance formula that C=ϵA/d. Electrodes on both ends must be arranged to form parallel plate capacitance. Portion of the second transparent electrode corresponding to the gate driver chip is hollowed and has no parallel capacitance. Therefore, the entire capacitance of the entire gate circuit is reduced, and an entire capacitance value is reduced to alleviate the problem of excessive RC load.

The present embodiment is optional. The gate circuit comprises at least one gate driver chip and at least one leading wire for transmitting a signal of the gate driver chip into the display area.

The second transparent electrode is hollowed in corresponding to a location of the leading wire. In the implementation solution, the leading wire in the gate circuit is hollowed, and it is known from a parallel capacitance formula that C=ϵA/d. Electrodes on both ends must be arranged to form a parallel plate capacitance. Portion of the second transparent electrode corresponding to the leading wire is hollowed and has no parallel capacitance. Therefore, the entire capacitance of the entire gate circuit is reduced, and an entire capacitance value is reduced to alleviate the problem of excessive RC load.

The present embodiment is optional. The gate circuit comprises at least one gate driver chip and at least one leading wire for transmitting a signal of the gate driver chip into the display area.

The second transparent electrode is hollowed in corresponding to a location of the gate driver chip and the leading wire. In the implementation solution, the leading wire and the gate driver chip in the gate circuit are hollowed, and it is known from a parallel capacitance formula that C=ϵA/d. Electrodes on both ends must be arranged to form parallel plate capacitance. Portions of the second transparent electrode corresponding to the leading wire and the gate driver chip are hollowed and have no parallel capacitance. Therefore, the entire capacitance of the entire gate circuit is reduced, and an entire capacitance value is reduced to alleviate the problem of excessive RC load.

The present embodiment is optional. The hollow area is formed in an exposing and developing manner. In the implementation solution, the hollow area be finished in an exposing and developing manner, and certainly can also be processed in other applicable manners.

A GOA product has the problem of excessive RC load in design primarily because GOA has excessive capacitance. If the capacitance at the gate circuit can be effectively reduced, the load problem can be effectively alleviated. In the present application, because the second transparent electrode of the second substrate is hollowed in corresponding to a location of the gate circuit, only horizontal capacitance between the gate circuit and the second transparent electrode exists since parallel capacitance between the first transparent electrode and the second transparent electrode is greatly reduced or even eliminated corresponding to a location of the gate circuit. The capacitance is greatly reduced than that before improvement, i.e., the solution of the present application effectively reduces the capacitance, and then alleviates the problem of excessive RC load.

The above contents are further detailed descriptions of the present application in combination with specific embodiments. However, the specific implementation of the present application shall not be considered to be only limited to these descriptions. For those of ordinary skill in the art to which the present application belongs, several simple deductions or replacements may be made without departing from the conception of the present application, all of which shall be considered to belong to the protection scope of the present application.

1. A display comprising:
a first substrate;
a second substrate arranged opposite to the first substrate; and
a liquid crystal layer positioned between the first substrate and the second substrate;
wherein the first substrate comprises a gate circuit and a display area arranged corresponding to the liquid crystal layer; and
the first substrate further comprises a first transparent electrode, the second substrate comprises a second transparent electrode and the second transparent electrode is provided with a hollow area corresponding to the gate circuit;
wherein the gate circuit comprises at least one gate driver chip and at least one leading wire for transmitting a signal of the gate driver chip into the display area, the hollow area is arranged corresponding to the leading wire and the gate driver chip, and the hollow area is formed in an exposing and developing manner.

2. A display panel, comprising:
a first substrate;
a second substrate arranged opposite to the first substrate; and
a liquid crystal layer positioned between the first substrate and the second substrate;
wherein the first substrate comprises a gate circuit and a display area corresponding to the liquid crystal layer; and the first substrate further comprises a first transparent electrode, the second substrate comprises a second transparent electrode, and the second transparent electrode is provided with a hollow area corresponding to the gate circuit.

3. The display panel according to claim 1, wherein the hollow area is formed in an exposing and developing manner.

4. The display panel according to claim 1, wherein the gate circuit comprises at least one gate driver chip and at least one leading wire for transmitting a signal of the gate driver chip into the display area; and
the hollow area is arranged corresponding to the gate driver chip.

5. The display panel according to claim 4, wherein the hollow area is formed in an exposing and developing manner.

6. The display panel according to claim 1, wherein the gate circuit comprises at least one gate driver chip and at least one leading wire for transmitting a signal of the gate driver chip into the display area; and
the hollow area is arranged corresponding to the leading wire.

7. The display panel according to claim 6, wherein the hollow area is formed in an exposing and developing manner.

8. The display panel according to claim 1, wherein the gate circuit comprises at least one gate driver chip and at least one leading wire for transmitting a signal of the gate driver chip into the display area; and
the hollow area is arranged corresponding to the gate driver chip and the leading wire.

9. The display panel according to claim 8, wherein the hollow area is formed in an exposing and developing manner.

10. A manufacturing method of a display panel, comprising steps:
forming a first substrate;
forming a second substrate arranged opposite to the first substrate;
filling liquid crystals between the first substrate and the second substrate to form a liquid crystal layer;
exposing and developing on the periphery of a first display area to form a gate circuit;
arranging a first transparent electrode and a second transparent electrode corresponding to the first substrate and the second substrate respectively; and
hollowing the second transparent electrode corresponding to a location of the gate circuit.

11. The display panel according to claim 10, wherein the hollow area is formed in an exposing and developing manner.

12. The display panel according to claim 10, wherein the gate circuit comprises at least one gate driver chip and at least one leading wire for transmitting a signal of the gate driver chip into the display area; and
the second transparent electrode is hollowed in corresponding to a location of the gate driver chip.

13. The display panel according to claim 12, wherein the hollow area is formed in an exposing and developing manner.

14. The display panel according to claim 10, wherein the gate circuit comprises at least one gate driver chip and at least one leading wire for transmitting a signal of the gate driver chip into the display area; and
the second transparent electrode is hollowed in corresponding to a location of the leading wire.

15. The display panel according to claim 14, wherein the hollow area is formed in an exposing and developing manner.

16. The display panel according to claim 10, wherein the gate circuit comprises at least one gate driver chip and at least one leading wire for transmitting a signal of the gate driver chip into the display area; and
the second transparent electrode is hollowed in corresponding to a location of the gate driver chip and the leading wire.

17. The display panel according to claim 16, wherein the hollow area is formed in an exposing and developing manner.
